(19) United States
(12) Patent Application Publication
(10) Pub. No.: US 2014/0222635 A1
(43) Pub. Date: Aug. 7, 2014

(54) System, Software, and Method for Reducing Fraud

(71) Applicant: Parvinder Chopra, New York, NY (US)

(72) Inventor: Parvinder Chopra, New York, NY (US)

(21) Appl. No.: 13/757,964

(22) Filed: Feb. 4, 2013

(51) Int. Cl. G06Q 20/34

(52) U.S. Cl. CPC G06Q 20/354
USPC 705/35

(57) ABSTRACT

A method for reducing fraud comprises providing a mobile device, wirelessly connecting to a server of a card issuer, the server comprising account information for a card issued to a card holder, the account information comprising a status regarding an activated or deactivated state, selecting a deactivated state, and sending a deactivate instruction from the mobile device to the server to cause the card to be deactivated.

### BACKGROUND OF THE INVENTION

The present invention relates to a credit card/Debit card security system for mobile and other applications.

There is a need to reduce fraud risk on credit and debit cards.

### SUMMARY OF THE INVENTION

In one aspect of the present invention, a system for reducing fraud comprises: a mobile device; and a program product comprising machine-readable program code for causing, when executed, the device to perform the following process steps: wirelessly connecting to a server of a card issuer, the server comprising account information for a card issued to a card holder, the account information comprising a status regarding an activated or deactivated state; prompting the card holder via the mobile device to select a deactivated state; and sending a deactivate instruction from the mobile device to the server to cause the card to be deactivated.

In one aspect, the program product comprises machine-readable program code for causing, when executed, the device to perform the following further process steps: prompting the card holder via the mobile device to select an activated state; and sending an activate instruction from the mobile device to the server to cause the card to be activated.

In one aspect of the present invention, a method for reducing fraud comprises: providing a mobile device; wirelessly connecting to a server of a card issuer, the server comprising account information for a card issued to a card holder, the account information comprising a status regarding an activated or deactivated state; selecting a deactivated state; and sending a deactivate instruction from the mobile device to the server to cause the card to be deactivated.

In one aspect, the method further comprises: selecting an activated state; and sending an activate instruction from the mobile device to the server to cause the card to be activated.

In one aspect, the method further comprises causing the card to be activated for a short window of time comprising not more than approximately five minutes. In one aspect, the method further comprises causing the card to be activated for a short window of time comprising not more than approximately one minute.

In one aspect, the method further comprises determining whether an attempt has been made to use the card when the card is in the deactivated state. In one aspect, the method further comprises identifying fraud if an attempt has been made to use the card when the card is in the deactivated state. In one aspect, the method further comprises identifying an IP address of a user who has attempted to use the card when the card is in the deactivated state.

In one aspect, the method further comprises: selecting an all-deactivated state; and sending an all-deactivate instruction from the mobile device to the server to cause a plurality of cards to be deactivated simultaneously.

These and other features, aspects and advantages of the present invention will become better understood with reference to the following drawings, description and claims.

### BRIEF DESCRIPTION OF THE DRAWINGS

FIG. 1: shows a front view screen shot of one embodiment of the invention.

FIG. 2: shows a flowchart of one embodiment of the invention.

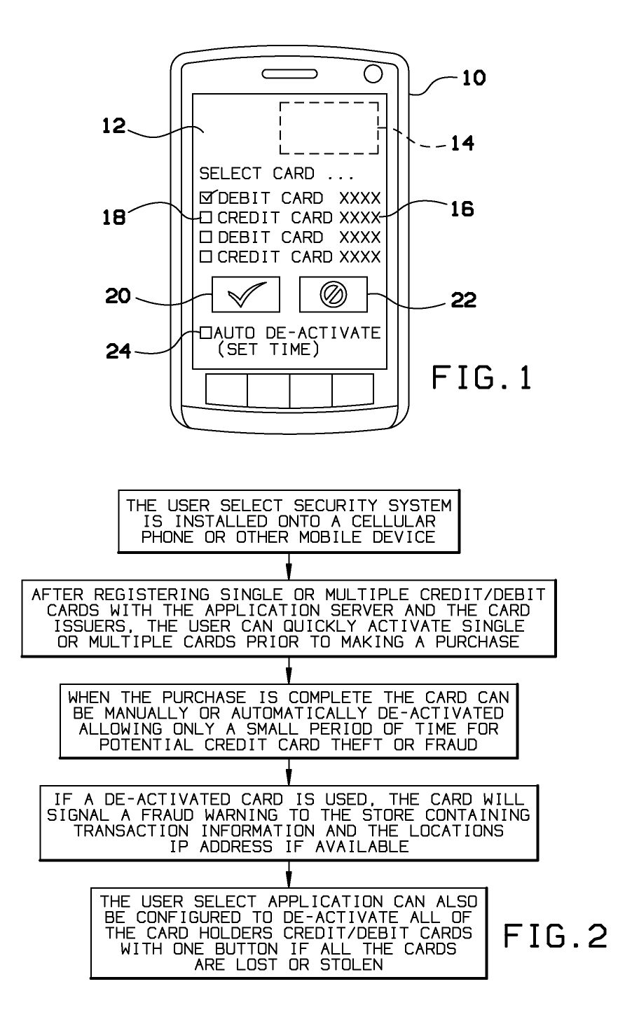

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Referring now to the figures, the following reference numbers may refer to elements of the invention:

10: is the cellular phone/mobile device.

12: is the cellular phone/mobile device screen.

14: is the credit/debit card issuers logo.

16: is the credit/debit card information.

18: is the credit/debit card check box.

20: is the activate button.

22: is the de-activate button.

24: is the auto de-activate check box.

The present invention includes a user select security system to allow the card holder to send a signal to the card issuer to activate or deactivate a single or multiple credit/debit card as and when required at the touch of a key on their mobile device or other application. It allows the card holder to activate his/her card when they are about to make a transaction; then, after the transaction, they press a key to de-activate the card to close the window of potential fraud on their card(s). This creates a very short window (such as less than 10 minutes, less than 5 minutes, less than 1 minute, less than 10 seconds, or even less than 1 second) in which any credit card fraudster can use the card for purchases. When the card is de-activated and when the card fraudster attempts use (such as in a store) the de-activated card, a fraud warning is signaled to the store and/or other potential parties, such as the card issuer, the cardholder, and others. For online frauds a similar signal could help get feedback of the IP address of where the card had been attempted to be used from, or even a physical location of where the fraud is being attempted.

This technique is easy to use. The present invention may include a stand-alone security key which the card holders could be given if cards are lost or stolen or not in use, to activate or deactivate all cards at the touch of a button, using an all-activate or all-deactivate button, which may cause all cards to be approximately simultaneously activated or deactivated. This eliminates the time taken to call card companies which may take hours if several companies are needed to be called in the case of stolen cards. For activate or deactivate purposes the key could be pressed when cards are required for use and when they are not being used.

### The Version of the Invention Discussed Here Includes:

1. Mobile device or computer system or processor, such as a smartphone, a tablet, or a laptop
2. Wireless connection, such as to the Internet or other server
3. Access to credit/debit card issuer to activate or de-activate cards multiple times

### How the Invention Works:

The activate or de-activate signal is the key send/receive signal to make this work. If the activate key is pressed then the device will send a signal to the card issuer to activate the card. If the deactivate key is pressed then the device will send a signal to the card issuer to de-activate the card. The invention works via a software application running on the device and transmitting and receiving signals from the device to and from the card issuer's server.

The present invention reduces liability to uninsured card holders and card issuers and also third party insurance companies and vendors who are all victims to credit card fraud.

The present invention includes a system for reducing fraud, comprising: a machine or device 10; and a program product comprising machine-readable program code for causing, when executed, the machine to perform the following process steps: wirelessly connecting to a server of a card issuer, the server comprising account information for a card issued to a card holder, the account information comprising a status regarding an activated or deactivated state; prompting the card holder via the mobile device 10 (such as on screen 12) to select a deactivated state, such as by clicking deactivate button 22; and sending a deactivate instruction from the mobile device 10 to the server to cause the card to be deactivated.

The method also includes: prompting the card holder via the mobile device 10 (such as on screen 12) to select an activated state, such as by clicking activate button 20; and sending an activate instruction from the mobile device 10 to the server to cause the card to be activated.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention.

What is claimed is:

1. A system for reducing fraud, comprising:
a mobile device; and
a program product comprising machine-readable program code for causing, when executed, the device to perform the following process steps:
wirelessly connecting to a server of a card issuer, the server comprising account information for a card issued to a card holder, the account information comprising a status regarding an activated or deactivated state;
prompting the card holder via the mobile device to select a deactivated state; and
sending a deactivate instruction from the mobile device to the server to cause the card to be deactivated.

2. The system as claimed in claim 1, wherein the program product comprises machine-readable program code for causing, when executed, the device to perform the following further process steps:
prompting the card holder via the mobile device to select an activated state; and
sending an activate instruction from the mobile device to the server to cause the card to be activated.

3. A method for reducing fraud, comprising:
providing a mobile device;
wirelessly connecting to a server of a card issuer, the server comprising account information for a card issued to a card holder, the account information comprising a status regarding an activated or deactivated state;
selecting a deactivated state; and
sending a deactivate instruction from the mobile device to the server to cause the card to be deactivated.

4. The method as claimed in claim 3, further comprising:
selecting an activated state; and
sending an activate instruction from the mobile device to the server to cause the card to be activated.

5. The method as claimed in claim 4, further comprising causing the card to be activated for a short window of time comprising not more than approximately five minutes.

6. The method as claimed in claim 5, further comprising causing the card to be activated for a short window of time comprising not more than approximately one minute.

7. The method as claimed in claim 3, further comprising determining whether an attempt has been made to use the card when the card is in the deactivated state.

8. The method as claimed in claim 7, further comprising identifying fraud if an attempt has been made to use the card when the card is in the deactivated state.

9. The method as claimed in claim 8, further comprising identifying an IP address of a user who has attempted to use the card when the card is in the deactivated state.

10. The method as claimed in claim 3, further comprising:
selecting an all-deactivated state; and
sending an all-deactivate instruction from the mobile device to the server to cause a plurality of cards to be deactivated simultaneously.
